(19) United States
(12) Patent Application Publication
(10) Pub. No.: US 2024/0114374 A1
(43) Pub. Date: Apr. 4, 2024

(54) CHANNEL STATE INFORMATION (CSI) ENHANCEMENTS IN SUBBAND FULL DUPLEX (SBFD)

(71) Applicant: MediaTek Singapore Pte. Ltd., Singapore (SG)

(72) Inventors: Emmanuel Munge CHEGE, Cambridge (GB); Jozsef Gabor NEMETH, Cambridge (GB); Sumaila Anning MAHAMA, Cambridge (GB); Mohammed S. Aleabe AL-IMARI, Cambridge (GB)

(73) Assignee: MediaTek Singapore Pte. Ltd., Singapore (SG)

(21) Appl. No.: 18/465,639

(22) Filed: Sep. 12, 2023

Related U.S. Application Data
(60) Provisional application No. 63/377,748, filed on Sep. 30, 2022.

(51) Int. Cl. H04W 24/10; H04L 5/14; H04W 24/08

(52) U.S. Cl. CPC H04W 24/10; H04L 5/14; H04W 24/08

(57) ABSTRACT

A method of CSI resource allocation in a subband full duplex (SBFD) system is disclosed. The method can include receiving a channel state information (CSI) resource configuration from a base station in a subband full duplex (SBFD) system, the CSI resource configuration being associated with one or more CSI reference signal (CSI-RS) resource set including at least one CSI-RS resource, the CSI resource configuration indicating a first CSI-RS resource distribution and a second CSI-RS resource distribution, each CSI-RS resource distribution indicates one or more frequency domain starting position and one or more total number of resource blocks of one or more partition of the respective CSI-RS resource set in CSI transmission slots, performing a channel measurement based on the one or more CSI-RS resource set and the CSI resource configuration, and transmitting a CSI report to the base station based on the channel measurement.

### INCORPORATION BY REFERENCE

This present application claims the benefit of U.S. Provisional Application No. 63/377,748, “CSI Enhancements in SBFD” filed on Sep. 30, 2022, which is incorporated herein by reference in its entirety.

### TECHNICAL FIELD

The present disclosure relates to channel state information (CSI) resource allocation in a wireless communication system employing a subband full duplex (SBFD) scheme.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Time division duplex (TDD) uses one carrier with flexible uplink (UL) and downlink (DL) ratios to meet asymmetric requirements for UL and DL. However, with a DL heavy TDD configuration, such as 4 DL slots and 1 UL slot for every TDD period, a network may provide a limited allocation of time domain resources for UL, resulting in reduced UL throughput and coverage as well as increased latency. In non-overlapping subband full duplex (SBFD) at base station side, an UL subband can be introduced within DL slots of a TDD period. Accordingly, UL reception and DL transmission can be performed simultaneously for a base station within a channel across UL and DL subbands coexisting in the original DL slots.

### SUMMARY

Aspects of the disclosure provide a method of CSI resource allocation in a subband full duplex (SBFD) system. The method can include receiving a channel state information (CSI) resource configuration from a base station in a subband full duplex (SBFD) system, the CSI resource configuration being associated with one or more CSI reference signal (CSI-RS) resource set including at least one CSI-RS resource, the CSI resource configuration indicating a first CSI-RS resource distribution and a second CSI-RS resource distribution, each CSI-RS resource distribution indicates one or more frequency domain starting position and one or more total number of resource blocks of one or more partition of the respective CSI-RS resource set in CSI transmission slots, performing a channel measurement based on the one or more CSI-RS resource set and the CSI resource configuration, and transmitting a CSI report to the base station based on the channel measurement.

In an embodiment, the first CSI-RS resource distribution is a contiguous CSI-RS resource distribution which indicates a single frequency domain starting position and a single total number of resource blocks of the respective CSI-RS resource set.

In an embodiment, the second CSI-RS resource distribution is a discontiguous CSI-RS resource distribution which indicates multiple frequency domain starting positions and multiple total number of resource blocks of respective multiple partitions of the respective CSI-RS resource set.

In an embodiment, each CSI-RS resource distribution is associated with one frequency domain occupation information element.

In an embodiment, in response to periodic or semi-persistent reporting, skipping the channel measurement of the CSI transmission slots being overlapped with uplink slots. In an embodiment, the CSI transmission slots being skipped are indicated by higher layer parameters. In an embodiment, the CSI transmission slots being skipped are indicated by a bitmap.

In an embodiment, the performing of the channel measurement is based on at least two CSI-RS resource sets and the CSI resource configuration in response to periodic or semi-persistent reporting. In an embodiment, the at least two CSI-RS resource sets are enabled or disabled separately. In an embodiment, each CSI-RS resource set is associated with one CSI report for transmitting to the base station. In an embodiment, at least one of the CSI-RS resource sets is based on a CSI-RS resource using contiguous resource blocks.

In an embodiment, each CSI-RS resource set includes at least two CSI-RS resources. In an embodiment, the performing the channel measurement is based on only one of the at least two CSI-RS resources. In an embodiment, only one CSI report is associated with the at least two CSI-RS resources for transmitting to the base station. In an embodiment, at least one of the at least two CSI-RS resources is using contiguous resource blocks.

In an embodiment, the CSI resource configuration is further associated with multiple CSI-RS resources each covering a contiguous set of resource blocks. In an embodiment, at least two CSI-RS resources are configured per CSI-RS resource set. In an embodiment, exactly two CSI-RS resources are configured per CSI-RS resource set in response to the CSI-RS resource set being associated with a type II codebook.

Aspects of the disclosure provide an apparatus comprising circuitry. The circuitry is configured to receive a channel state information (CSI) resource configuration from a base station in a subband full duplex (SBFD) system, the CSI resource configuration being associated with one or more CSI reference signal (CSI-RS) resource set including at least one CSI-RS resource, the CSI resource configuration indicating a first CSI-RS resource distribution and a second CSI-RS resource distribution, each CSI-RS resource distribution indicates one or more frequency domain starting position and one or more total number of resource blocks of one or more partition of the respective CSI-RS resource set in CSI transmission slots, perform a channel measurement based on the one or more CSI-RS resource set and the CSI resource configuration, and transmit a CSI report to the base station based on the channel measurement.

Aspects of the disclosure provide a non-transitory computer-readable medium storing instructions that, when executed by a processor, cause the processor to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication system 100 according to an embodiment of the disclosure.

FIG. 2 shows a layout 200 of time-frequency radio resource allocation for subband full duplex (SBFD) operation in a serving cell of the UE 102.

FIGS. 3A-3C show CSI-RS resource configurations in Legacy TDD and SBFD.

FIG. 4 shows the existing 3GPP parameters for contiguous CSI resource configuration.

FIG. 5 shows an example of the parameters of the CSI resource configuration according to the embodiments of the disclosure.

FIG. 6 shows examples where CSI-RS resources are configured for periodic/semi-persistent transmission in SBFD.

FIG. 7 shows an example of CSI transmission process 700 in a SBFD system according to an embodiment of the disclosure.

FIG. 8 shows an apparatus 800 according to embodiments of the disclosure.

### DETAILED DESCRIPTION OF EMBODIMENTS

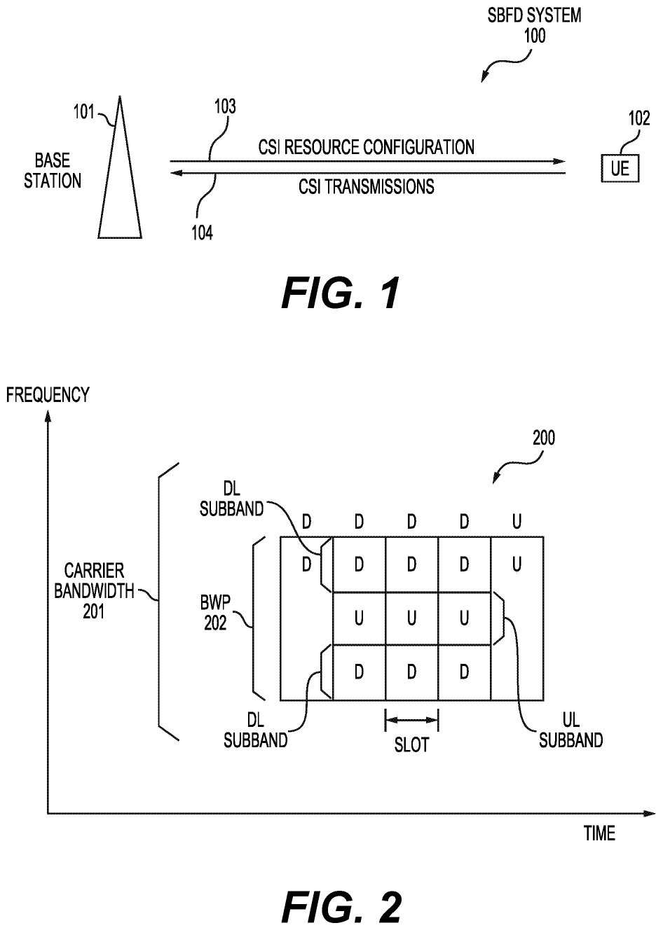

FIG. 1 shows a wireless communication system 100 according to an embodiment of the disclosure. The system 100 can include a base station (BS) 101 and a user equipment (UE) 102. The BS 101 and the UE 102 can generally operate according to the communication standards developed by the 3rd Generation Partnership Project (3GPP) or other wireless communication protocols.

The BS 101 can operate in a non-overlapping subband full duplex (SBFD) mode. To explain the SBFD mode, FIG. 2 shows a layout 200 of time-frequency radio resource allocation for SBFD operation in a serving cell of the UE 102. For example, the UE 102 can be configured with a bandwidth part (BWP) 202 within a carrier bandwidth 201. The UE 102 can also receive an SBFD-related configuration indicating the layout 200 of time-frequency radio resource allocation. The layout 200 of time-frequency radio resource allocation can be based on a time division duplex (TDD) uplink (UL)/downlink (DL) configuration having a 5-slot time domain pattern of [D D D D U], where D represents a DL slot and U represents a UL slot. A set of subbands is introduced in the DL slots. For example, according to the configuration, for each of the middle three DL slots, the frequency resources can be partitioned into 2 DL subbands and 1 UL subband, as shown in FIG. 2.

With the introduction of the UL subbands into the original DL slots, the BS 101 can operate in the so-called SBFD mode during these partitioned slots: DL transmission and UL reception can be conducted in the DL subbands and UL subbands, respectively and simultaneously. The partitioned slots can be referred to as SBFD slots. The first full DL slot and the last full UL slot shown in FIG. 2 can be referred to as non-SBFD slots. On the layout shown in FIG. 2, D indicates the respective radio resources configured for DL transmissions, and U indicates the respective radio resources configured for UL transmissions. In the SBFD slots, the UE 102 can operate in full duplex or half duplex, for example, depending on the capability of the UE 102.

In operation, as shown in FIG. 1, the UE 102 may perform uplink transmissions 104 based on CSI resource configurations 103 received from the BS 101. For example, the uplink transmissions 104 can include transmissions of CSI measurement report, and other physical channels or signals. The uplink transmissions can be periodic, semi-persistent, or aperiodic. Some of the uplink transmissions 104 can be repetitive across multiple continuous slots.

It is noted that, while the resource allocation layout for SBFD operation shown in FIG. 2 has a subband-partition pattern of [D U D], other subband-partition patterns are possible in various embodiments. For example, the subband-partition patterns can be [D U] or [U D].

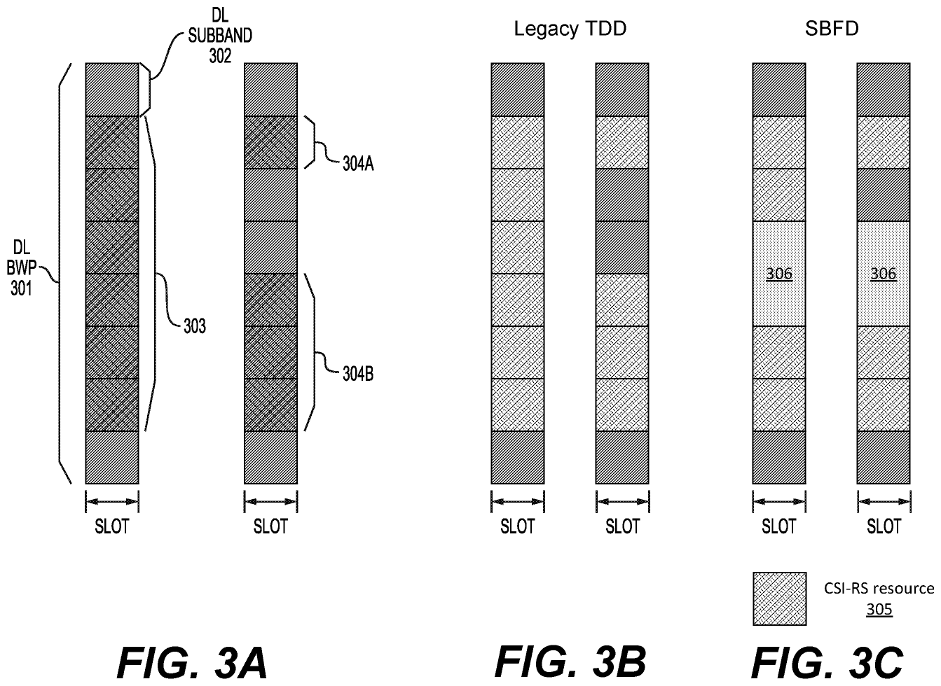

FIGS. 3A-3C show CSI-RS resource configurations in Legacy TDD and SBFD. FIG. 3A shows two DL BWPs 301 that are configured with CSI-RS reporting bands (303, 304A, and 304B). The CSI-RS reporting band 303 is a contiguous reporting band that covers multiple contiguous DL subbands 302. The CSI-RS reporting bands 304A and 304B are configured to be a discontiguous CSI-RS reporting band where some DL subbands 302 in between are not configured for CSI-RS reporting. FIG. 3B shows the allocation of CSI-RS resources 305 on the DL according to the CSI-RS reporting bands in legacy TDD. For example, a BS can allocate CSI-RS resources 305 on the contiguous or discontiguous CSI-RS reporting band (303, 304A, and 304B) for a UE to measure and report the CSI quality. FIG. 3C shows a UL subband 306 being allocated in the middle of the DL subbands in an SBFD system. For example, a UL subband 306 can be allocated in the middle of CSI-RS reporting band 304A which results in a discontiguous CSI-RS reporting band. For example, a UL subband 306 can be allocated to cover part of CSI-RS reporting band 304C along with some non-reporting DL subbands.

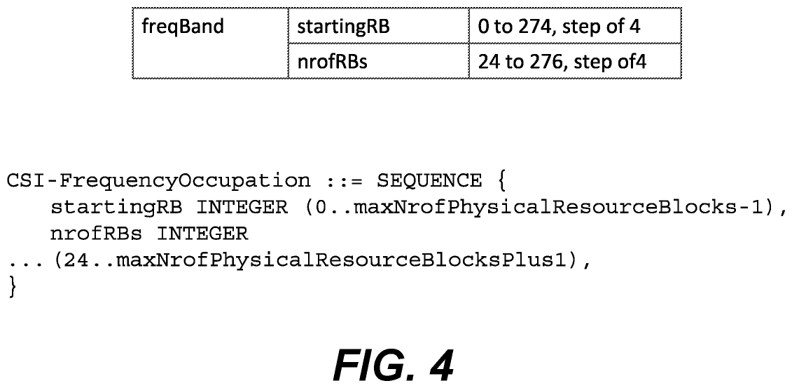

However, with the specification of existing 3GPP standards, it is not possible to configure a single contiguous CSI-RS resource to cover the contiguous CSI-RS reporting band as part of the resources being overlapped with the UL subbands. FIG. 4 shows the existing 3GPP parameters for contiguous CSI resource configuration. In order to perform channel measurements on the two DL subbands, the BS requires two separate non-contiguous CSI resources to be allocated in the two DL subbands. However, this leads to a limitation on the number of CSI-RS resources that can be allocated in the DL BWP as the total number of resources in a resource set has to be split between the two DL subbands. If the reportQuantity parameter in the CSI-ReportConfig is set to cri-RI-PMI-CQI/cri-RI-i1/cri-RI-i1-CQI/cri-RI-CQI or cri-RI-LI-PMI-CQI, a UE can only be configured with a maximum of 8 CSI-RS resources in a CSI-RS resource set contained within a resource setting. For example, as shown in FIG. 3C, a maximum of 4 resources can be allocated in each DL subband that has been divided by a UL subband 306 if the 8 CSI-RS resources are being equally distributed. Furthermore, the existing 3GPP standards limit the number of resource sets to one for periodic and semi-persistent resource settings. For example, A UE is not expected to be configured with more than one CSI-RS resource in a resource set for channel measurement for a CSI-ReportConfig with the higher layer parameter codebookType set to typeII or to typeII-PortSelection. In addition, if interference measurement is performed on non-zero power (NZP) CSI-RS, a UE is not expected to be configured with more than one NZP CSI-RS resource in the associated resource set within the resource setting for channel measurement. Therefore, the channel/interference measurements performed by a UE would be limited to one of the two DL subbands.

Aspects of the disclosure provide solutions for solving the above problem. For example, preserving the current contiguous CSI-RS resource allocation by reconstructing the CSI-FrequencyOccupation information element with additional parameters. Alternatively, a different information element, for example, CSI-FrequencyOccupation2 can be defined which can be used to configure discontiguous CSI-RS resources. In the occasion that a valid periodic semi-persistent contiguous CSI-RS resource falls within an SBFD slot with part of the resource overlapping with the UL subband, the BS should have the capability of instructing the UE to skip/invalidate measurement of this resource for a multi-slot transmission.

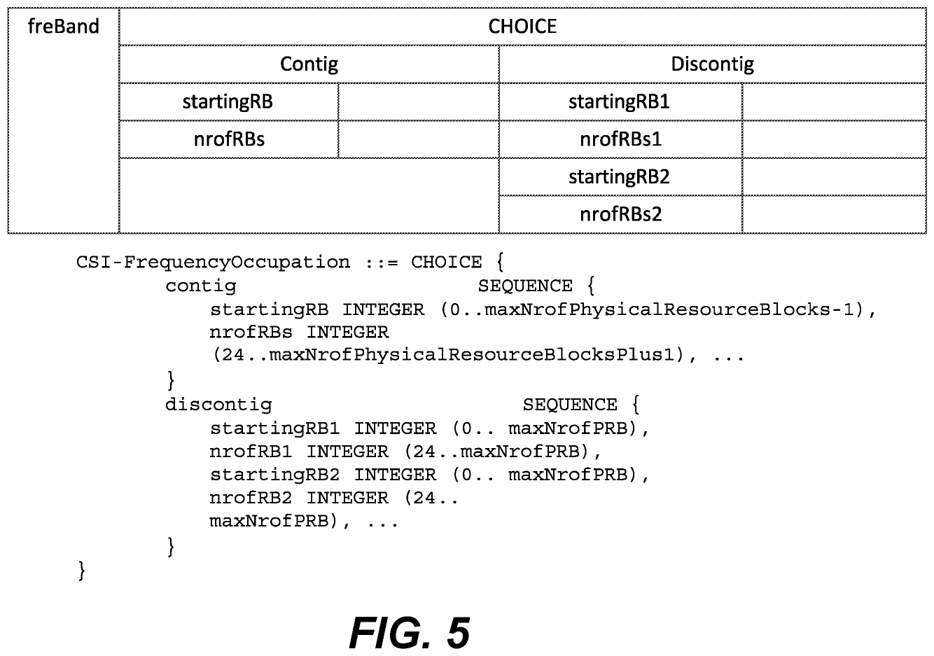

To solve the above problems, the following enhancements to CSI-RS resource allocation for SBFD can be considered. FIG. 5 shows an example of the parameters of the CSI resource configuration according to the embodiments of the disclosure.

In one embodiment, define two new parameters that can configure the CSI-RS resource distribution as being contiguous or discontiguous in the frequency domain resource occupation (e.g., CSI-FrequencyOccupation information element) of a CSI-RS resource. The first parameter contig can be used to configure a CSI-RS resource that is contiguous in the frequency domain for a specific set of slots. The second parameter discontig can be used to configure a CSI-RS resource that is discontiguous in the frequency domain for a specific set of slots.

In one embodiment, the contig CSI-RS resource distribution can include two parameters startingRB and nrofRBs. The startingRB can be used to define the starting position of the CSI-RS resource for a specific set of slots. The nrofRBs can be used to define the total number of resource blocks (RBs) the CSI-RS resource occupies in a specific set of slots. The contig CSI-RS resource distribution is similar to the existing 3GPP specification exhibits.

In one embodiment, the discontig CSI-RS resource distribution can include a list of parameters that are defined to specify the different CSI-RS resource starting positions and the number of RBs each partition of the discontiguous CSI-RS resource will occupy. For example, in a two-partition discontiguous CSI-RS resource distribution setting, the parameter startingRB can be used to define the starting position of the first partition of the discontiguous CSI-RS resource for a specific set of slots. The nrofRBs can be used to define the total number of resource blocks (RBs) of the first partition of the discontiguous CSI-RS resource occupies in a specific set of slots. The parameter startingRB2 can be used to define the starting position of the second partition of the discontiguous CSI-RS resource for a specific set of slots. The nrofRBs2 can be used to define the total number of resource blocks (RBs) of the second partition of the discontiguous CSI-RS resource occupies in a specific set of slots. FIG. 5 shows parameters for

In one embodiment, a new frequency domain occupation information element (e.g., CSI-FrequencyOccupation2) can be defined to configure the frequency domain occupation of a discontiguous CSI-RS resource. The CSI-FrequencyOccupation information element in the existing 3GPP specifications can remain used to configure contiguous CSI-RS resources.

In one embodiment, the new CSI-FrequencyOccupation2 information element can include a list of parameters that are defined to specify the different CSI-RS resource starting positions and the number of RBs each partition of the discontiguous CSI-RS resource will occupy. For example, in a two-partition discontiguous CSI-RS resource distribution setting, the parameter startingRB can be used to define the starting position of the first partition of the discontiguous CSI-RS resource for a specific set of slots. The nrofRBs can be used to define the total number of resource blocks (RBs) the first partition of the discontiguous CSI-RS resource occupies in a specific set of slots. The parameter startingRB2 can be used to define the starting position of the second partition of the discontiguous CSI-RS resource for a specific set of slots. The nrofRBs2 can be used to define the total number of resource blocks (RBs) the second partition of the discontiguous CSI-RS resource occupies in a specific set of slots.

A CSI-RS resource can be configured for periodic, semi-persistent, or aperiodic transmission. In some embodiments, for periodic/semi-persistent CSI-RS resources used for periodic/aperiodic/semi-persistent CSI measurement reporting, disabling/invalidating/skipping the CSI-RS resource in specific slots can be performed.

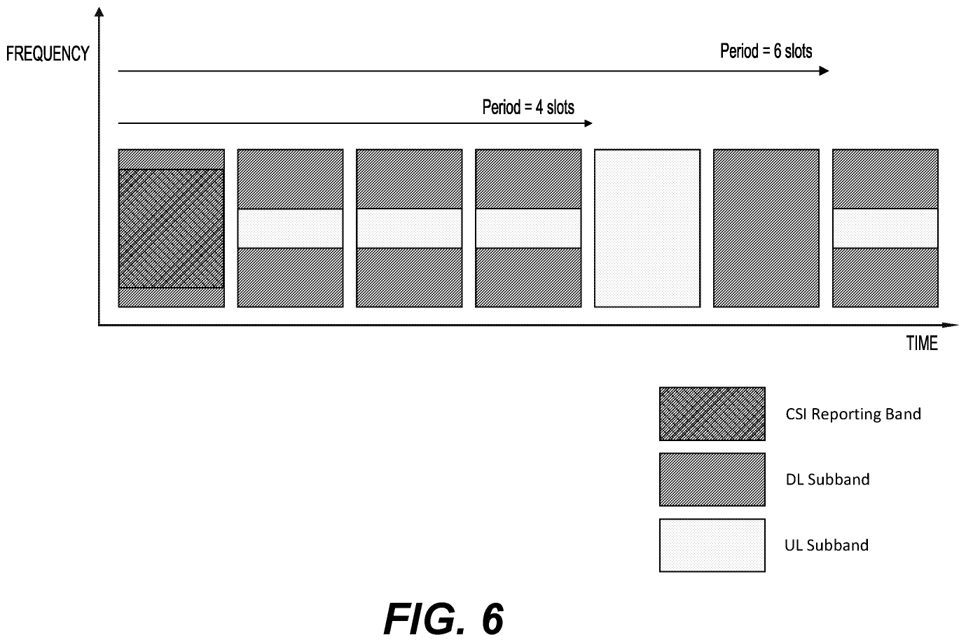

FIG. 6 shows examples where CSI-RS resources are configured for periodic/semi-persistent transmission in SBFD. CSI-RS resource transmissions with a periodicity of 4 slots and 6 slots are shown. The CSI-RS resources are allocated within the CSI reporting band frequency range.

In one embodiment, the CSI-RS resource measurement at the UE is disabled/skipped/invalidated if the configured contiguous CSI-RS resource is positioned in the CSI reporting band which overlaps with the UL subband in an SBFD slot. For example, when the CSI-RS resource is transmitted with a periodicity of 4 slots, the UE is configured to disable/skip/invalidate the CSI-RS resource measurement for the CSI-RS resource for the entire 5th slot. For example, when the CSI-RS resource is transmitted with a periodicity of 6 slots, the UE is configured to disable/skip/invalidate the CSI-RS resource measurement for the CSI-RS resource for the middle section of the 7th slot.

In one embodiment, the slots in which the UE is to disable/skip/invalidate the CSI-RS resource measurement are indicated by a high-layer parameter(s). In one embodiment, a bitmap can be used to indicate the slots in which the UE is to disable/skip/invalidate the CSI-RS resource measurement. In one embodiment, the bitmap is defined for TDD pattern configured by high-layer parameter tdd-UL-DL-ConfigurationCommon. In one embodiment, the length of the bitmap is given by the total number of slots signed by tdd-UL-DL-ConfigurationCommon. In one embodiment, the bit value for each slot is determined by the SBFD slot configuration or layer. For example, bit value=0 can represent the set of slots that are not partitioned, i.e., non-SBFD slots (DL-only or UL-only slots). For example, bit value=1 can represent the set of slots that are partitioned, i.e., SBFD slots. In one embodiment, a CSI-RS measurement is skipped/disabled/invalidated if the configured CSI-RS resource overlaps (partially or fully) with UL subband in a slot with bit value=1.

In some embodiments, the UE can be configured with two CSI-RS resource sets for periodic/semi-persistent reporting of the CSI. Each CSI-RS resource set is configured to include CSI-RS resources. In each slot, the CSI-RS resources belonging to a single CSI-RS set can be validated and measured by the UE. In one embodiment, the two CSI-RS resource sets are enabled/disabled together for semi-static reporting. In one embodiment, the two CSI-RS resource sets are enabled/disabled separately for semi-persistent reporting. In one embodiment, part of the parameters of the two CSI-RS resource sets are configured separately for periodic/semi-persistent reporting. For example, the CSI reporting band for the CSI-RS resources to be transmitted is configured differently for the two CSI-RS resource sets. In one embodiment, all parameters of the two CSI-RS resource sets are configured separately for periodic/semi-persistent reporting.

In some embodiments, the UE is configured with two CSI-RS resources for a single CSI-RS resource set for periodic/semi-persistent reporting, despite being configured with high-layer parameter codebookType set to type11 or type11-PortSelection and the interference measurement is performed on NZP CSI-RS. In one embodiment, each slot can only have one of the two CSI-RS resources being validated and measured by the UE. In one embodiment, the UE is configured to generate a single report containing one set of values for the two CSI-RS resources. In one embodiment, the UE is configured to generate a single report containing separate sets of values for each CSI-RS resource. In one embodiment, at least one of the CSI-RS resources is using contiguous RBs.

In some embodiments, multiple CSI-RS resources each covering a contiguous set of RBs are configured to cover discontiguous CSI-RS measurement regions. In one embodiment, two or more CSI-RS resources each covering a contiguous set of RBs are configured for each CSI-RS resource set. In one embodiment, exactly two CSI-RS resources each covering a contiguous set of RBs are configured for each CSI-RS resource set being configured with high-layer parameter codebookType set to type11 or type11-PortSelection and the interference measurement is performed on NZP CSI-RS. In addition, both of the two CSI-RS resources can be validated and measured by the UE in a same slot.

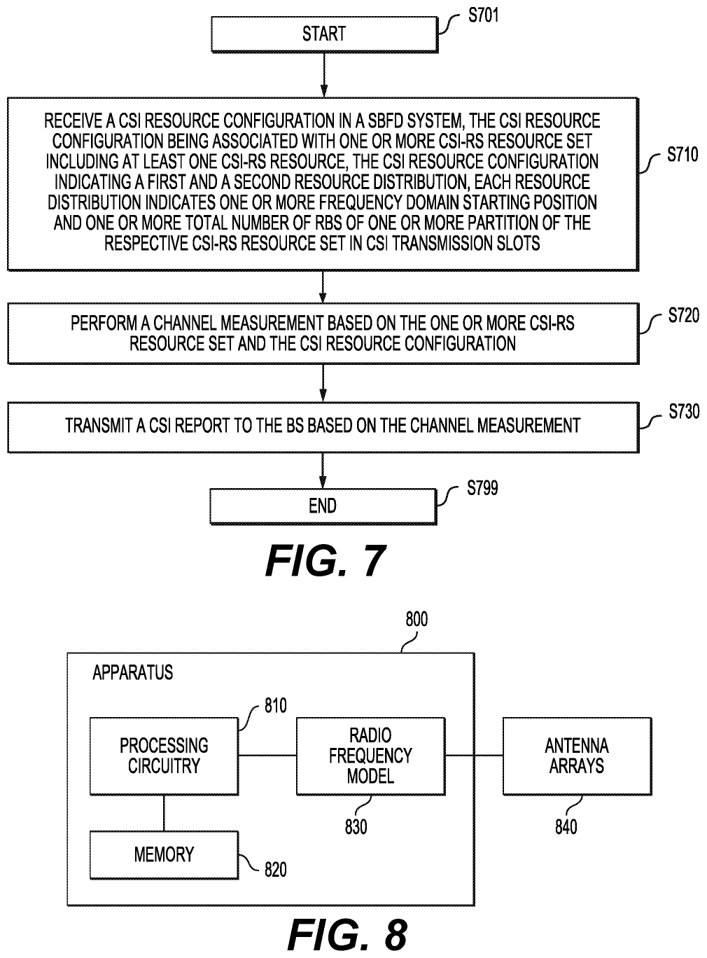

FIG. 7 shows an example of CSI transmission and reporting process 700 according to embodiments of the disclosure. The process 700 can be performed by a UE. The process 700 can start from S501 and proceed to S710.

At S710, a CSI resource configuration can be received from a base state in a SBFD system. The CSI resource configuration is associated with one or more CSI-RS resource set including at least one CSI-RS resource. The CSI resource configuration indicates a first and a second CSI-RS resource distribution, each CSI-RS resource distribution indicates one or more frequency domain starting position and one or more total number of RBs of one or more partition of the respective CSI-RS resource set in CSI transmission slots.

In an embodiment, the first CSI-RS resource distribution is a contiguous CSI-RS resource distribution that indicates a single frequency domain starting position and a single total number of RBs of the respective CSI-RS resource set. For example, the first CSI-RS resource distribution can indicate a parameter startingRB for the frequency domain starting position and a parameter nrofRBs for the total number of RB s.

In an embodiment, the second CSI-RS resource distribution is a discontiguous CSI-RS resource distribution that indicates multiple frequency domain starting positions and multiple total number of RBs of respective multiple partitions of the respective CSI-RS resource set. For example, the second CSI-RS resource distribution can indicate parameters startingRB and startingRB2 for the frequency domain starting position of each partition and parameters nrofRBs and nrofRBs2 for the total number of RBs of each partition.

In an embodiment, each CSI-RS resource distribution is associated with one frequency domain occupation information element. For example, the first CSI-RS resource distribution can be associated with the CSI-FrequencyOccupation information element. For example, the second CSI-RS resource distribution can be associated with the CSI-FrequencyOccupation2 information element. Each frequency domain occupation information element can include its own set of parameters for the frequency domain starting position and total number of RBs of each partition of the slots.

In an embodiment, the CSI resource configuration can indicate at least two CSI-RS resource sets for periodic/semi-persistent reporting. In an embodiment, at least one of the CSI-RS resource sets is based on a CSI-RS resource using contiguous RBs for periodic/semi-persistent reporting. In an embodiment, each CSI-RS resource set includes at least two CSI-RS resources for periodic/semi-persistent reporting. In an embodiment, at least one of the at least two CSI-RS resources is using contiguous RBs for periodic/semi-persistent reporting.

In an embodiment, the CSI resource configuration can be associated with multiple CSI-RS resources each covering a contiguous set of resource blocks. For example, the CSI resource configuration can indicate at least two CSI-RS resources per CSI-RS resource set. For example, the CSI resource configuration can indicate exactly two CSI-RS resources per CSI-RS resource set if the CSI-RS resource set is associated with a type II codebook.

At S720, a channel measurement based on the one or more CSI-RS resource set and the CSI resource configuration can be performed. In an embodiment, the UE can skip the channel measurement of the CSI transmission slots being overlapped with uplink slots if the CSI-RS resources are periodic or semi-persistent CSI-RS. In an embodiment, the CSI transmission slots being skipped can be indicated by high-layer parameters. In an embodiment, the CSI transmission slots being skipped are indicated by a bitmap.

In an embodiment, the channel measurement can be performed on at least two CSI-RS resource sets for periodic/semi-persistent reporting. In an embodiment, the channel measurement can be performed based on each CSI-RS resource set being enabled or disabled separately for periodic/semi-persistent reporting. In an embodiment, the channel measurement can be performed based on at least one of the CSI-RS resource sets being configured to use contiguous RBs for periodic/semi-persistent reporting.

In an embodiment, if each CSI-RS resource set includes at least two CSI-RS resources, the channel measurement can be performed on only one of the at least two CSI-RS resources. In an embodiment, the channel measurement can be performed based on at least one of the CSI-RS resources being configured to use contiguous RBs. In an embodiment, the channel measurement can be performed on CSI-RS resource sets that are configured with at least two CSI-RS resources. In an embodiment, the channel measurement can be performed on CSI-RS resource sets that are configured with exactly two CSI-RS resources.

At S730, a CSI report based on the channel measurement can be transmitted to the base station. In an embodiment, each CSI-RS resource set can be associated with one CSI report for periodic/semi-persistent reporting. In an embodiment, if at least two CSI-RS resources are configured per CSI-RS resource set, only one CSI report can be transmitted to the base station. The process 700 proceeds to S799 and terminates at S799.

FIG. 8 shows an exemplary apparatus 800 according to embodiments of the disclosure. The apparatus 800 can be configured to perform various functions in accordance with one or more embodiments or examples described herein. Thus, the apparatus 800 can provide means for implementation of mechanisms, techniques, processes, functions, components, systems described herein. For example, the apparatus 800 can be used to implement functions of UEs or BSs in various embodiments and examples described herein. The apparatus 800 can include a general purpose processor or specially designed circuits to implement various functions, components, or processes described herein in various embodiments. The apparatus 800 can include processing circuitry 810, a memory 820, and a radio frequency (RF) module 830.

In various examples, the processing circuitry 810 can include circuitry configured to perform the functions and processes described herein in combination with software or without software. In various examples, the processing circuitry 810 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 810 can be a central processing unit (CPU) configured to execute program instructions to perform various functions and processes described herein. Accordingly, the memory 820 can be configured to store program instructions. The processing circuitry 810, when executing the program instructions, can perform the functions and processes. The memory 820 can further store other programs or data, such as operating systems, application programs, and the like. The memory 820 can include non-transitory storage media, such as a read only memory (ROM), a random access memory (RAM), a flash memory, a solid state memory, a hard disk drive, an optical disk drive, and the like.

In an embodiment, the RF module 830 receives a processed data signal from the processing circuitry 810 and converts the data signal to beamforming wireless signals that are then transmitted via antenna arrays 840, or vice versa. The RF module 830 can include a digital to analog converter (DAC), an analog to digital converter (ADC), a frequency up converter, a frequency down converter, filters and amplifiers for reception and transmission operations. The RF module 830 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 840 can include one or more antenna arrays.

The apparatus 800 can optionally include other components, such as input and output devices, additional or signal processing circuitry, and the like. Accordingly, the apparatus 800 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a channel state information (CSI) resource configuration from a base station in a subband full duplex (SBFD) system, the CSI resource configuration being associated with one or more CSI reference signal (CSI-RS) resource set including at least one CSI-RS resource, the CSI resource configuration indicating a first CSI-RS resource distribution and a second CSI-RS resource distribution, each CSI-RS resource distribution indicates one or more frequency domain starting position and one or more total number of resource blocks of one or more partition of the respective CSI-RS resource set in CSI transmission slots;
performing a channel measurement based on the one or more CSI-RS resource set and the CSI resource configuration; and
transmitting a CSI report to the base station based on the channel measurement.

2. The method of claim 1, wherein the first CSI-RS resource distribution is a contiguous CSI-RS resource distribution indicates a single frequency domain starting position and a single total number of resource blocks of the respective CSI-RS resource set.

3. The method of claim 1, wherein the second CSI-RS resource distribution is a discontiguous CSI-RS resource distribution indicates multiple frequency domain starting positions and multiple total number of resource blocks of respective multiple partitions of the respective CSI-RS resource set.

4. The method of claim 1, wherein each CSI-RS resource distribution is associated with one frequency domain occupation information element.

5. The method of claim 1, wherein in response to periodic or semi-persistent reporting, skipping the channel measurement of the CSI transmission slots being overlapped with uplink slots.

6. The method of claim 5, wherein the CSI transmission slots being skipped are indicated by higher layer parameters.

7. The method of claim 5, wherein the CSI transmission slots being skipped are indicated by a bitmap.

8. The method of claim 1, wherein in response to periodic or semi-persistent reporting, the performing of the channel measurement is based on at least two CSI-RS resource sets and the CSI resource configuration.

9. The method of claim 8, wherein the at least two CSI-RS resource sets are enabled or disabled separately.

10. The method of claim 8, wherein each CSI-RS resource set is associated with one CSI report for transmitting to the base station.

11. The method of claim 8, wherein at least one of the CSI-RS resource sets is based on a CSI-RS resource using contiguous resource blocks.

12. The method of claim 1, wherein each CSI-RS resource set includes at least two CSI-RS resources.

13. The method of claim 12, wherein the performing the channel measurement is based on only one of the at least two CSI-RS resources.

14. The method of claim 12, wherein only one CSI report is associated with the at least two CSI-RS resources for transmitting to the base station.

15. The method of claim 12, wherein at least one of the at least two CSI-RS resources is using contiguous resource blocks.

16. The method of claim 1, wherein the CSI resource configuration is further associated with multiple CSI-RS resources each covering a contiguous set of resource blocks.

17. The method of claim 16, wherein at least two CSI-RS resources are configured per CSI-RS resource set.

18. The method of claim 16, wherein exactly two CSI-RS resources are configured per CSI-RS resource set in response to the CSI-RS resource set is associated with a type II codebook.

19. An apparatus, comprising circuitry configured to:
receive a channel state information (CSI) resource configuration from a base station in a subband full duplex (SBFD) system, the CSI resource configuration being associated with one or more CSI reference signal (CSI-RS) resource set including at least one CSI-RS resource, the CSI resource configuration indicating a first CSI-RS resource distribution and a second CSI-RS resource distribution, each CSI-RS resource distribution indicates one or more frequency domain starting position and one or more total number of resource blocks of one or more partition of the respective CSI-RS resource set in CSI transmission slots;
perform a channel measurement based on the one or more CSI-RS resource set and the CSI resource configuration; and
transmit a CSI report to the base station based on the channel measurement.

20. A non-transitory computer-readable medium storing instructions that, when executed by a processor, cause the processor to perform a method, the method comprising:
receiving a channel state information (CSI) resource configuration from a base station in a subband full duplex (SBFD) system, the CSI resource configuration being associated with one or more CSI reference signal (CSI-RS) resource set including at least one CSI-RS resource, the CSI resource configuration indicating a first CSI-RS resource distribution and a second CSI-RS resource distribution, each CSI-RS resource distribution indicates one or more frequency domain starting position and one or more total number of resource blocks of one or more partition of the respective CSI-RS resource set in CSI transmission slots;
performing a channel measurement based on the one or more CSI-RS resource set and the CSI resource configuration; and
transmitting a CSI report to the base station based on the channel measurement.
